(19) United States
(12) Patent Application Publication
(10) Pub. No.: US 2025/0069798 A1
(43) Pub. Date: Feb. 27, 2025

(54) COIL ELECTRONIC COMPONENT

(71) Applicant: SAMSUNG ELECTRO-MECHANICS CO., LTD., Suwon-si (KR)

(72) Inventors: Juhwan Yang, Suwon-si (KR); Minji Cho, Suwon-si (KR); Boumseock Kim, Suwon-si (KR)

(73) Assignee: SAMSUNG ELECTRO-MECHANICS CO., LTD., Suwon-si (KR)

(21) Appl. No.: 18/793,265

(22) Filed: Aug. 2, 2024

(30) Foreign Application Priority Data
Aug. 22, 2023 (KR) 10-2023-0109484

(51) Int. Cl. H01F 27/30; H01F 1/20; H01F 27/255; H01F 27/28; H01F 27/29; H01F 27/32

(52) U.S. Cl. CPC H01F 27/306; H01F 27/255; H01F 27/2847; H01F 27/29; H01F 27/323; H01F 1/20

(57) ABSTRACT

Disclosed is a coil electronic component including: a main body including a first magnetic body, and a second magnetic body facing the first magnetic body; a first coil, at least a portion of which is embedded in the first magnetic body; and a second coil, at least a portion of which is embedded in the second magnetic body, in which the first magnetic body is an integral structure having a recess, and the first coil is disposed in the recess.

### CROSS-REFERENCE TO RELATED APPLICATION

This application claims priority to and the benefit of Korean Patent Application No. 10-2023-0109484 filed in the Korean Intellectual Property Office on Aug. 22, 2023, the entire contents of which are incorporated herein by reference.

### BACKGROUND

### Field

The present disclosure relates to a coil electronic component.

### Description of the Related Art

Recently, functions of mobile devices have diversified, which has increased power consumption. In order to extend the running time of batteries in the mobile devices, coil electronic components with low loss and high efficiency are being employed around the power management integrated circuit (PMIC).

In case that the coil electronic component has a coupled inductor structure in which a first coil and a second coil are vertically arranged, there is a need for a method capable of easily adjusting a coupling coefficient (coefficient of coupling, k) while ensuring high inductance.

In addition, it is necessary to prevent the first and second coils from being misaligned with each other during a process of stacking the first coil and the second coil.

### SUMMARY

The present disclosure attempts to provide a coil electronic component having a coupled inductor structure and capable of easily adjusting a coupling coefficient while ensuring high inductance.

The present disclosure also attempts to provide a coil electronic component having a coupled inductor structure and capable of preventing stacked coils from being misaligned.

However, the object to be achieved by the present embodiments is not limited to the above-mentioned object but may be variously expanded without departing from the technical spirit of the present disclosure.

A coil electronic component according to an embodiment includes: a main body including a first magnetic body, and a second magnetic body facing the first magnetic body; a first coil, at least a portion of which is embedded in the first magnetic body; and a second coil, at least a portion of which is embedded in the second magnetic body, in which the first magnetic body is an integral structure having a recess, and the first coil is disposed in the recess.

In addition, the first magnetic body may include a base portion, a protruding portion protruding from the base portion, and a support portion spaced apart from the protruding portion and protruding from the base portion, the recess is defined by the base portion, the protruding portion and the support portion, and the first coil is wound around the protruding portion.

In addition, the main body may further include a third magnetic body between the first magnetic body and the second magnetic body.

In addition, an outer surface of the third magnetic body and an outer surface of the first magnetic body may comprise an outer surface of the main body.

In addition, the third magnetic body may be at least partially in contact with the second coil and the second magnetic body.

In addition, a height of the protruding portion and a height of the support portion may be different.

In addition, the third magnetic body may be at least partially in contact with the first coil, the protruding portion, and the support portion.

In addition, the first coil may be surrounded by the base portion, the protruding portion, the support portion, and the third magnetic body.

In addition, the third magnetic body may include a portion between the first coil and the protruding portion.

In addition, the third magnetic body may include a portion between the first coil and the support portion.

In addition, an aspect ratio of the first coil may be 1.25:1 or more and 5:1 or less, and an aspect ratio of the second coil may be 1.25:1 or more and 5:1 or less.

In addition, a coupling coefficient of the first coil and the second coil may be 0.17 or more and 0.33 or less.

In addition, the coil electronic component may further include a first external electrode disposed outside the main body and connected to a first lead-out portion of the first coil; a second external electrode disposed outside the main body and connected to a second lead-out portion of the first coil; a third external electrode disposed outside the main body and connected to a first lead-out portion of the second coil; and a fourth external electrode disposed outside the main body and connected to a second lead-out portion of the second coil.

In addition, the first external electrode and the second external electrode may each include a first electrode layer connected to the first coil, a second electrode layer covering the first electrode layer, and a third electrode layer covering the second electrode layer, and the third external electrode and the fourth external electrode may each include a fourth electrode layer connected to the second coil, a fifth electrode layer covering the fourth electrode layer, and a sixth electrode layer covering the fifth electrode layer.

In addition, the first electrode layer and the fourth electrode layer may each include copper (Cu).

In addition, the first electrode layer and the fourth electrode layer may each be a conductive resin layer.

In addition, the coil electronic component may further include an insulation layer covering a surface of the main body between the first external electrode, the second external electrode, the third external electrode, and the fourth external electrode.

In addition, the coil electronic component may further include an insulation film on a surface of the first coil and a surface of the second coil.

In addition, the third magnetic body may have magnetic permeability different from magnetic permeability of the first magnetic body and the second magnetic body.

In addition, the third magnetic body may include a material different from materials of the first magnetic body and the second magnetic body.

In addition, the first magnetic body, the second magnetic body, and the third magnetic body may each include metal magnetic particles made of a soft magnetic alloy.

According to the coil electronic component according to the embodiment, it is possible to easily adjust the coupling coefficient while ensuring high inductance.

According to the coil electronic component according to the embodiment, it is possible to prevent the stacked coils from being misaligned.

### BRIEF DESCRIPTION OF THE DRAWINGS

FIG. 1 is a perspective view schematically illustrating a coil electronic component according to an embodiment.

FIG. 2 is a top plan view schematically illustrating the coil electronic component in FIG. 1.

FIG. 3 is a bottom plan view schematically illustrating the coil electronic component in FIG. 1.

FIG. 4 is a schematic cross-sectional view taken along line IV-IV′ in FIG. 1.

FIG. 5 is a perspective view schematically illustrating a first magnetic body of the coil electronic component in FIG. 1.

FIG. 6 is a schematic cross-sectional view taken along line VI-VI′ in FIG. 5.

FIG. 7 is a cross-sectional view schematically illustrating a first magnetic body of a coil electronic component according to a modified example.

FIG. 8 is a perspective view schematically illustrating a first magnetic body of a coil electronic component according to another modified example.

FIG. 9 is a cross-sectional view schematically illustrating a coil electronic component according to another embodiment.

### DETAILED DESCRIPTION OF THE EMBODIMENTS

Hereinafter, embodiments of the present disclosure will be described in detail with reference to the accompanying drawings so that those with ordinary skill in the art to which the present disclosure pertains may easily carry out the embodiments. In the drawings, a part irrelevant to the description will be omitted to clearly describe the present disclosure, and the same or similar constituent elements will be designated by the same reference numerals throughout the specification. Some constituent elements in the accompanying drawings are illustrated in an exaggerated or schematic form or are omitted. A size of each constituent element does not entirely reflect an actual size.

In addition, it should be understood that the accompanying drawings are provided only to allow those skilled in the art to easily understand the embodiments disclosed in the present specification, and the technical spirit disclosed in the present specification is not limited by the accompanying drawings, and includes all alterations, equivalents, and alternatives that are included in the spirit and the technical scope of the present disclosure.

The terms including ordinal numbers such as “first,” “second,” and the like may be used to describe various constituent elements, but the constituent elements are not limited by the terms. These terms are used only to distinguish one constituent element from another constituent element.

In addition, when one component such as a layer, a film, a region, or a plate is described as being positioned “above” or “on” another component, one component can be positioned “directly on” another component, and one component can also be positioned on another component with other components interposed therebetween. On the contrary, when one component is described as being positioned “directly above” another component, there is no component therebetween. In addition, when a component is described as being positioned “above” or “on” a reference part, the component may be positioned “above” or “below” the reference part, and this configuration does not necessarily mean that the component is positioned “above” or “on” the reference part in a direction opposite to gravity.

Throughout the specification, it should be understood that the terms “comprises,” “comprising,” “includes,” “including,” “containing,” “has,” “having” or other variations thereof are inclusive and therefore specify the presence of stated features, integers, steps, operations, elements, components, or combinations thereof, but do not preclude the presence or addition of one or more other features, integers, steps, operations, elements, components, or combinations thereof. Therefore, unless explicitly described to the contrary, the word “comprise/include” and variations such as “comprises/includes” or “comprising/including” will be understood to imply the inclusion of stated elements, not the exclusion of any other elements.

In addition, throughout the specification, the phrase “in a plan view” means when an object is viewed from above, and the phrase “in a cross-sectional view” means when a cross section made by vertically cutting an object is viewed from a lateral side.

In addition, throughout the specification, when one constituent element is referred to as being “connected to” another constituent element, one constituent element can be “directly connected to” the other constituent element, and one constituent element can also be “indirectly connected to,” “physically connected to,” or “electrically connected to” the other element with other elements therebetween. Further, the constituent elements are defined as different names according to positions or functions thereof, but the constituent elements may be integrated.

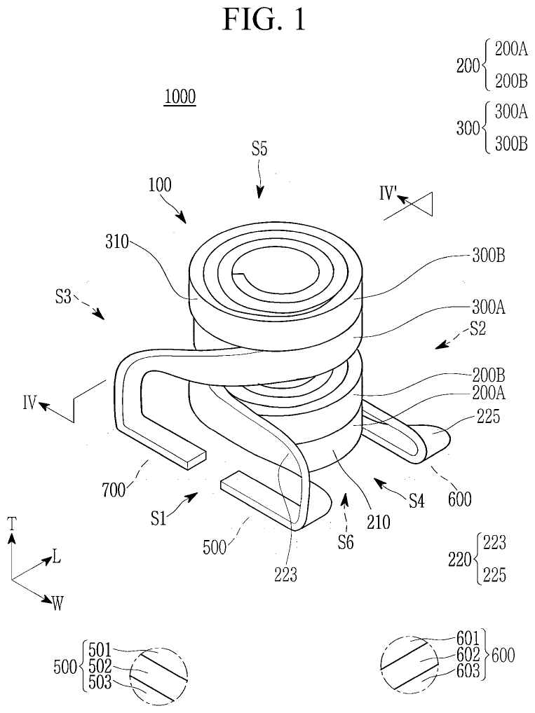

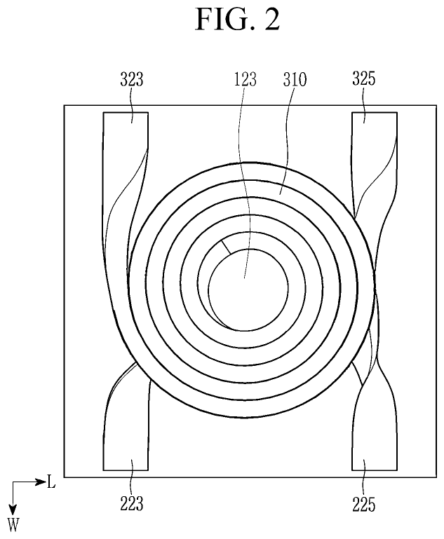

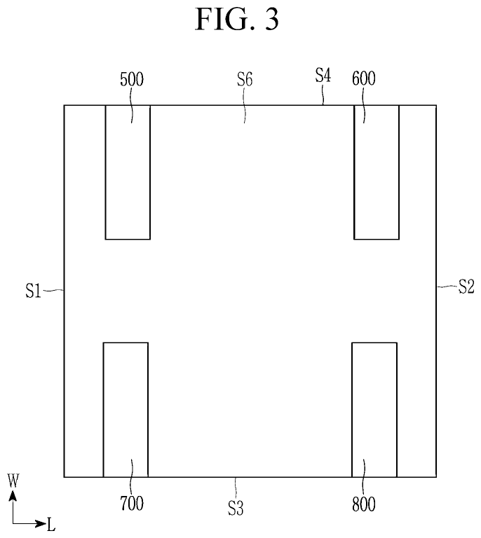

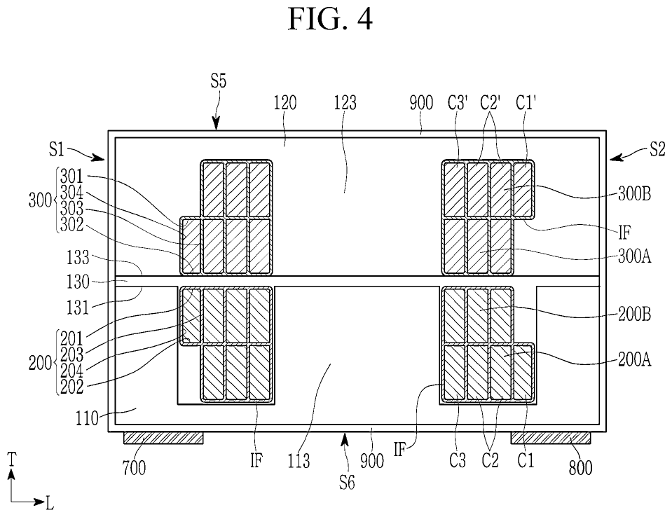

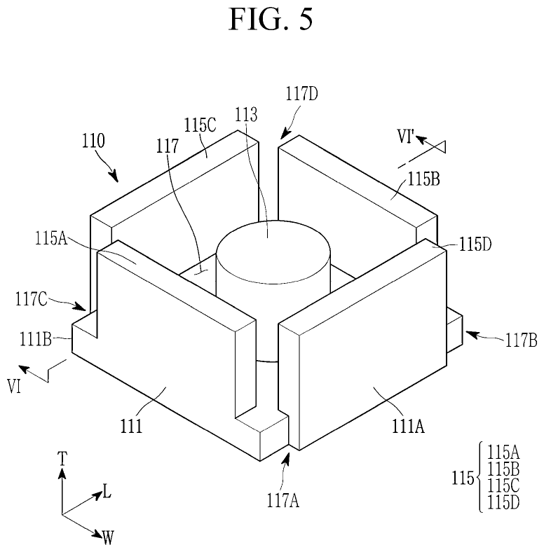

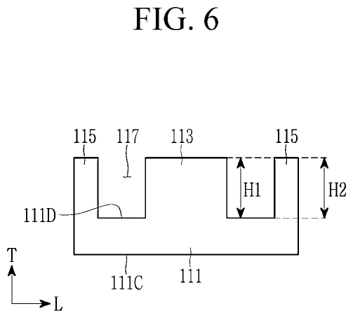

FIG. 1 is a perspective view schematically illustrating a coil electronic component according to the embodiment, FIG. 2 is a top plan view schematically illustrating the coil electronic component in FIG. 1, FIG. 3 is a bottom plan view schematically illustrating the coil electronic component in FIG. 1, FIG. 4 is a schematic cross-sectional view taken along line IV-IV′ in FIG. 1, FIG. 5 is a perspective view schematically illustrating a first magnetic body of the coil electronic component in FIG. 1, and FIG. 6 is a schematic cross-sectional view taken along line VI-VI′ in FIG. 5.

With reference to FIGS. 1, 2, 3, 4, 5, and 6, a coil electronic component 1000 according to an embodiment includes a main body 100, a first coil 200, a second coil 300, a first external electrode 500, a second external electrode 600, a third external electrode 700, and a fourth external electrode 800.

The main body 100 may have an approximately rectangular parallelepiped shape. However, the present embodiment is not limited thereto. The main body 100 may have a substantially rectangular parallelepiped shape, instead of a complete rectangular parallelepiped shape, due to shrinkage of magnetic powder during a sintering process. For example, the main body 100 has an approximately rectangular parallelepiped shape, but a portion of the main body 100, which corresponds to an edge or vertex, may have a round shape.

In the present embodiment, for convenience of description, two surfaces, which are opposite to each other in a length direction (L-axis direction), are respectively defined as a first surface S1 and a second surface S2, two surfaces, which are opposite to each other in a width direction (W-axis direction), are respectively defined as a third surface S3 and a fourth surface S4, and two surfaces, which are opposite to each other in a thickness direction (T-axis direction), are respectively defined as a fifth surface S5 and a sixth surface S6.

Based on an optical microscope or scanning electron microscope (SEM) photograph of a cross-section (taken in the length direction (L-axis direction) and the thickness direction (T-axis direction)) of a central portion of the coil electronic component 1000 in the width direction (W-axis direction), a length of the coil electronic component 1000 may mean a maximum value among lengths of a plurality of line segments that connects two outermost boundary lines, which are opposite to each other in the length direction (L-axis direction) of the coil electronic component 1000 shown in the above-mentioned photograph of the cross-section, and is parallel to the length direction (L-axis direction). Alternatively, the length of the coil electronic component 1000 may mean a minimum value among the lengths of the plurality of line segments that connects the two outermost boundary lines, which are opposite to each other in the length direction (L-axis direction) of the coil electronic component 1000 shown in the above-mentioned photograph of the cross-section, and is parallel to the length direction (L-axis direction). Alternatively, the length of the coil electronic component 1000 may mean an arithmetic mean value of the lengths of at least two line segments among the plurality of line segments that connects the two outermost boundary lines, which are opposite to each other in the length direction (L-axis direction) of the coil electronic component 1000 shown in the above-mentioned photograph of the cross-section, and is parallel to the length direction (L-axis direction).

Based on an optical microscope or scanning electron microscope (SEM) photograph of the cross-section (taken in the length direction (L-axis direction) and the thickness direction (T-axis direction)) of the central portion of the coil electronic component 1000 in the width direction (W-axis direction), a thickness of the coil electronic component 1000 may mean a maximum value among the lengths of the plurality of line segments that connects two outermost boundary lines, which are opposite to each other in the thickness direction (T-axis direction) of the coil electronic component 1000 shown in the above-mentioned photograph of the cross-section, and is parallel to the thickness direction (T-axis direction). Alternatively, the thickness of the coil electronic component 1000 may mean a minimum value among the lengths of the plurality of line segments that connects the two outermost boundary lines, which are opposite to each other in the thickness direction (T-axis direction) of the coil electronic component 1000 shown in the above-mentioned photograph of the cross-section, and is parallel to the thickness direction (T-axis direction). Alternatively, the thickness of the coil electronic component 1000 may mean an arithmetic mean value of the lengths of at least two line segments among the plurality of line segments that connects the two outermost boundary lines, which are opposite to each other in the thickness direction (T-axis direction) of the coil electronic component 1000 shown in the above-mentioned photograph of the cross-section, and is parallel to the thickness direction (T-axis direction).

Based on an optical microscope or scanning electron microscope (SEM) photograph of a cross-section (taken in the length direction (L-axis direction) and the width direction (W-axis direction)) of the central portion of the coil electronic component 1000 in the thickness direction (T-axis direction), a width of the coil electronic component 1000 may mean a maximum value among lengths of a plurality of line segments that connects two outermost boundary lines, which are opposite to each other in the width direction (W-axis direction) of the coil electronic component 1000 shown in the above-mentioned photograph of the cross-section, and is parallel to the width direction (W-axis direction). Alternatively, the width of the coil electronic component 1000 may mean a minimum value among the lengths of the plurality of line segments that connects the two outermost boundary lines, which are opposite to each other in the width direction (W-axis direction) of the coil electronic component 1000 shown in the above-mentioned photograph of the cross-section, and is parallel to the width direction (W-axis direction). Alternatively, the width of the coil electronic component 1000 may mean an arithmetic mean value of the lengths of at least two line segments among the plurality of line segments that connects the two outermost boundary lines, which are opposite to each other in the width direction (W-axis direction) of the coil electronic component 1000 shown in the above-mentioned photograph of the cross-section, and is parallel to the width direction (W-axis direction).

Meanwhile, the length, width, and thickness of the coil electronic component 1000 may be measured in a micrometer measurement method. The micrometer measurement method may be performed by setting a zero point by using a micrometer with Gage R&R (repeatability and reproducibility), inserting the coil electronic component 1000 according to the present embodiment between tips of the micrometer, and rotating a measurement lever of the micrometer. Meanwhile, at the time of measuring the length of the coil electronic component 1000 by using the micrometer measurement method, the length of the coil electronic component 1000 may mean a value measured once or an arithmetic mean of values measured multiple times. The same may also apply to the measurement of the width and thickness of the coil electronic component 1000.

The main body 100 comprises an external appearance of the coil electronic component 1000 and provides a space in which a magnetic path, which is a route along which magnetic flux induced by the first coil 200 and magnetic flux induced by the second coil 300 pass, is formed when a current is applied to the first coil 200 through the first external electrode 500 and the second external electrode 600 and a current is applied to the second coil 300 through the third external electrode 700 and the fourth external electrode 800.

The main body 100 surrounds and encapsulates the first coil 200 and the second coil 300 and includes magnetic materials. The main body 100 may include magnetic particles, and insulating materials may be interposed between the magnetic particles.

For example, the main body 100 may include a first magnetic body 110, a second magnetic body 120, and a third magnetic body 130. The first magnetic body 110, the second magnetic body 120, and the third magnetic body 130 may respectively include magnetic particles, and insulating materials may be interposed between the magnetic particles. The first magnetic body 110, the second magnetic body 120, and the third magnetic body 130 will be described below.

The magnetic material may include a first metal magnetic powder, a second metal magnetic powder having a larger particle diameter than the first metal magnetic powder, and a third metal magnetic powder having a larger particle diameter than the second metal magnetic powder. An average particle diameter D₅₀ of the first metal magnetic powder may be 0.1 μm or more and 0.2 μm or less, an average particle diameter D₅₀ of the second metal magnetic powder may be 1 μm or more and 2 μm or less, and an average particle diameter D₅₀ of the third metal magnetic powder may be 25 μm or more and 30 μm or less.

The magnetic particles may be ferrite particles or metal magnetic particles exhibiting magnetic properties.

For example, the ferrite particles may be one or more of spinel-type ferrite such as Mg—Zn-based, Mn—Zn-based, Mn—Mg-based, Cu—Zn-based, Mg—Mn—Sr-based, or Ni—Zn-based ferrite, hexagonal ferrites such as Ba—Zn-based, Ba—Mg-based, Ba—Ni-based, Ba—Co-based, or Ba—Ni—Co-based ferrite, garnet-type ferrite such as Y-based ferrite, and Li-based ferrite.

The metal magnetic particles may comprise two or more types of powders having different compositions and include one or more types selected from the group consisting of iron (Fe), silicon (Si), chromium (Cr), cobalt (Co), molybdenum (Mo), aluminum (Al), niobium (Nb), copper (Cu), and nickel (Ni). For example, the metal magnetic particle may be made of pure iron or a soft magnetic alloy. In case that the metal magnetic particle is made of a soft magnetic alloy, the metal magnetic particle may be made of one or more of a Fe—Si-based alloy, a Fe—Si—Al-based alloy, a Fe—Ni-based alloy, a Fe—Ni—Mo-based alloy, a Fe—Ni—Mo—Cu-based alloy, a Fe—Co-based alloy, a Fe—Ni—Co-based alloy, a Fe—Cr-based alloy, a Fe—Cr—Si-based alloy, a Fe—Si—Cu—Nb-based alloy, a Fe—Ni—Cr-based alloy, and a Fe—Cr—Al-based alloy. In this case, the different compositions of the metal magnetic particles may also mean different contents.

The metal magnetic particle may be amorphous or crystalline. For example, the metal magnetic particle may be made of a Fe—Si—B—Cr-based amorphous alloy. However, the present embodiment is not limited thereto. The average particle diameter of the metal magnetic particles may be about 0.1 to 30 μm. However, the present embodiment is not limited thereto. In the present specification, the average particle diameter may mean a particle size distribution expressed by D₉₀, D₅₀, or the like. The particle size distribution is well known to those skilled in the art, as an indicator that indicates what proportion of particles of what sizes (particle diameters) are contained in a population of particle that is to be measured. D₅₀ (particle diameter corresponding to 50% of a cumulative volume of particle size distribution) indicates an average particle diameter.

The metal magnetic particles may be two or more different types of metal magnetic particles. In this case, the different types of metal magnetic particles mean that the metal magnetic particles are distinguished from one another in terms of at least one of an average particle diameter, a composition, a component ratio, a crystallinity, and a shape.

The insulating material may include epoxy, polyimide, liquid crystal polymer, and the like, alone or in combination. However, the present embodiment is not limited thereto.

The first coil 200 and the second coil 300 may be disposed inside the main body 100 and exhibit the characteristics of the coil electronic component. For example, in case that the coil electronic component 1000 of the present embodiment is used as a power inductor, when a current is applied to the first coil 200 and the second coil 300, the first coil 200 and the second coil 300 store energy in the form of a magnetic field and maintain an output voltage, thereby stabilizing a power source of an electronic device.

The first coil 200 and the second coil 300 may be magnetically coupled and comprise a coupled inductor structure.

The first coil 200 and the second coil 300 may be in the form of spirally wound metal (e.g., copper (Cu) or silver (Ag)) wire with a surface coated with an insulating material. That is, the first coil 200 and the second coil 300 may be wound coils. The first coil 200 and the second coil 300 are not limited to a single wire but may comprise a stranded wire or two or more wires.

The first coil 200 and the second coil 300 may each be a circular coil. However, the present embodiment is not limited thereto. For example, the first coil 200 and the second coil 300 may each be various publicly-known coils, such as a rectangular coil, an oval or elliptical coil, and the like.

A cross-section of an individual wire of each of the first and second coils 200 and 300 may have various publicly-known shapes, such as a rectangular shape, a circular shape, and an elliptical shape.

In case that a cross-section of the individual wire of the first coil 200 has an approximately rectangular shape, the individual wire of the first coil 200 may have a first coil surface 201, a second coil surface 202, a third coil surface 203, and a fourth coil surface 204. The first coil surface 201 and the second coil surface 202 are opposite to each other in the thickness direction (T-axis direction). The third coil surface 203 and the fourth coil surface 204 connect the first coil surface 201 and the second coil surface 202 and are opposite to each other in the length direction (L-axis direction).

In case that a cross-section of the individual wire of the second coil 300 has an approximately rectangular shape, the individual wire of the second coil 300 may have a first coil surface 301, a second coil surface 302, a third coil surface 303, and a fourth coil surface 304. The first coil surface 301 and the second coil surface 302 are opposite to each other in the thickness direction (T-axis direction). The third coil surface 303 and the fourth coil surface 304 connect the first coil surface 301 and the second coil surface 302 and are opposite to each other in the length direction (L-axis direction).

The first coil 200 and the second coil 300 may each include a plurality of layers. The first coil 200 may include a lower coil 200A and an upper coil 200B. The upper coil 200B may be connected to the lower coil 200A. The upper coil 200B may be disposed above the lower coil 200A, i.e., disposed relatively closer to the fifth surface S5 of the main body 100 and comprise a layer. The second coil 300 may include a lower coil 300A and an upper coil 300B. The upper coil 300B may be connected to the lower coil 300A. The upper coil 300B may be disposed above the lower coil 300A, i.e., disposed relatively closer to the fifth surface S5 of the main body 100 and comprise a layer.

The first coil 200 and the second coil 300 may each have a plurality of turns.

For example, the first coil 200 may have an outermost turn coil C1, at least one intermediate turn coil C2, and an innermost turn coil C3 sequentially in a direction toward an inner side of the main body 100 from an outer surface of the main body 100.

Likewise, the second coil 300 may have an outermost turn coil C1′, at least one intermediate turn coil C2′, and an innermost turn coil C3′ sequentially in a direction toward the inner side of the main body 100 from the outer surface of the main body 100.

An insulation film IF may be disposed along a surface of each of the plurality of turns of each of the first and second coils 200 and 300. The insulation film IF may serve to protect and insulate the plurality of turns of the first and second coils 200 and 300 and include a publicly-known insulating material, such as parylene. Any material may be used as the insulating material included in the insulation film IF, and the insulating material is not particularly limited. For example, the insulation film IF may comprise polyurethane resin, polyester resin, epoxy resin, or polyamide imide resin. The insulation film IF may be formed by a method such as vapor deposition. However, the present embodiment is not limited thereto.

The first coil 200 may include a wound portion 210 and lead-out portions 220.

The wound portion 210 is a portion where the metal wire comprises at least one turn.

The lead-out portions 220 respectively extend from two opposite ends of the wound portion 210 and are exposed from the sixth surface S6 of the main body 100. The lead-out portions 220 include a first lead-out portion 223 and a second lead-out portion 225. The first lead-out portion 223 extends from one end of the wound portion 210 and is exposed from the sixth surface S6 of the main body 100, and the second lead-out portion 225 extends from the other end of the wound portion 210 and is exposed from the sixth surface S6 of the main body 100.

Meanwhile, the portions of the first lead-out portion 223 and the second lead-out portion 225 that are exposed from the sixth surface S6 of the main body 100 may be spaced apart from each other in the length direction (L-axis direction). However, the present embodiment is not limited thereto.

The second coil 300 may include a wound portion 310 and lead-out portions 320.

The wound portion 310 is a portion where the metal wire comprises at least one turn.

The lead-out portions 320 respectively extend from two opposite ends of the wound portion 310 and are exposed from the sixth surface S6 of the main body 100. The lead-out portions 320 include a first lead-out portion 323 and a second lead-out portion 325. The first lead-out portion 323 extends from one end of the wound portion 310 and is exposed from the sixth surface S6 of the main body 100, and the second lead-out portion 325 extends from the other end of the wound portion 310 and is exposed from the sixth surface S6 of the main body 100.

Meanwhile, the portions of the first lead-out portion 323 and the second lead-out portion 325 that are exposed from the sixth surface S6 of the main body 100 may be spaced apart from each other in the length direction (L-axis direction). However, the present embodiment is not limited thereto.

If the length of the coil electronic component is constant, the larger the width of the core of the main body, the larger the area of the magnetic path, which may increase the inductance. In addition, the smaller the size of a margin portion of the main body in the length direction (L-axis direction), the more the inductance may increase. That is, if the size of the margin portion decreases, the coil may be disposed farther away from a center of the main body to that extent, such that the width of the core may increase and the inductance may increase.

In order to increase the inductance by increasing the width of the core of the coil electronic component and decreasing the size of the margin portion, a ratio of the thickness and the width of the cross-section of each of the first and second coils 200 and 300, that is an aspect ratio, may be adjusted in the present embodiment.

The aspect ratio of the cross-section of the first coil 200 may be 1.25:1 or more and 5:1 or less, and the aspect ratio of the cross-section of the second coil 300 may be 1.25:1 or more and 5:1 or less.

If the aspect ratio is smaller than 1.25:1, the width of the core is excessively small, and the inductance may decrease. That is, a coupling coefficient of the first and second coils 200 and 300 may have a minus value. If the aspect ratio is larger than 5:1, the width of the core is excessively large, and the inductance may decrease. That is, a coupling coefficient of the first and second coils 200 and 300 may have a minus value.

The aspect ratio of the cross-section of the first coil 200 and the aspect ratio of the cross-section of the second coil 300 are calculated on the basis of the thickness and width of the cross-section of the first coil 200 and the thickness and width of the cross-section of the second coil 300 that are measured based on an optical microscope or scanning electron microscope (SEM) photograph of a cross-section (hereinafter, referred to as an “L-T cross-section”) taken in the length direction (L-axis direction) and the thickness direction (T-axis direction) perpendicular to the width direction (W-axis direction) at a central portion of the coil electronic component 1000 in the width direction (W-axis direction).

For example, the thickness of the cross-section of the first coil 200 (or the second coil 300) may mean a maximum value among lengths of a plurality of line segments that connects two opposite ends of the cross-section in the thickness direction in the above-mentioned L-T cross-sectional photograph. The width of the cross-section of the first coil 200 (or the second coil 300) may mean a maximum value among lengths of a plurality of line segments that connects two opposite ends of the cross-section in the width direction in the above-mentioned L-T cross-sectional photograph.

As another example, the thickness of the cross-section of the first coil 200 (or the second coil 300) may mean an arithmetic mean value between a maximum value and a minimum value among lengths of a plurality of line segments that connects two opposite ends of the cross-section in the thickness direction in the above-mentioned L-T cross-sectional photograph. The width of the cross-section of the first coil 200 (or the second coil 300) may mean an arithmetic mean value between a maximum value and a minimum value among lengths of a plurality of line segments that connects two opposite ends of the cross-section in the width direction in the above-mentioned L-T cross-sectional photograph. However, if the cross-section has a protruding or convex region in the thickness direction, the width may be measured from the remaining region, except for this region.

Based on the thickness and width of the cross-section of the first coil 200 (or the second coil 300) measured as above, an aspect ratio of the first coil 200 (or the second coil 300) may be calculated. For example, the aspect ratio of the first coil 200 (or the second coil 300) may be an arithmetic mean value of the aspect ratios of the cross-sections measured on the basis of the above-mentioned L-T cross-section photograph.

The main body 100 may include the first magnetic body 110, the second magnetic body 120, and the third magnetic body 130.

The first magnetic body 110 surrounds and encapsulates the first coil 200 and includes magnetic materials. The first magnetic body 110 may include magnetic particles, and insulating materials may be interposed between the magnetic particles.

The first magnetic body 110 includes a base portion 111, a protruding portion 113, a support portion 115, and a concave portion 117, and comprises an external appearance of the main body 100. In other words, the first magnetic body 110 includes a recess which is defined by the base portion 111, the protruding portion 113, and the support portion 115, and the first coil 200 is disposed in the recess. The first magnetic body 110 may comprise a part of the first surface S1, a part of the second surface S2, a part of the third surface S3, a part of the fourth surface S4, and the sixth surface S6 of the main body 100. Meanwhile, the first magnetic body 110 may be an integral structure. That is, the base portion 111, the protruding portion 113, and the support portion 115 of the first magnetic body 110 may be integrally formed. For example, the first magnetic body 110 may be formed by filling a mold with a magnetic material. The first magnetic body 110 may be formed by filling a mold with a composite material that includes magnetic materials and insulating resin.

In some embodiments, as illustrated in FIG. 6, the cross-section of the first magnetic body 110 taken in the length direction (L-axis direction) and the thickness direction (T-axis direction) may have the shape or appearance of the alphabet E. That is, the protruding portion 113 is disposed at a center of the base portion 111, and the support portions 115 are respectively disposed at two opposite edges of the base portion 111 and spaced apart from the protruding portion 113. A height H1 of the protruding portion 113 and a height H2 of the support portion 115 may be the same.

The height of the protruding portion 113 and the height of the support portion 115 are measured on the basis of an optical microscope or scanning electron microscope (SEM) photograph of a cross-section (taken in the length direction (L-axis direction) and the thickness direction (T-axis direction)) at a central portion of the coil electronic component 1000 in the width direction (W-axis direction). The height of the protruding portion 113 and the height of the support portion 115 may be arithmetic mean values of the height of the protruding portion 113 and the height of the support portion 115 at five equally spaced points on the protruding portion 113 and the support portion 115 of the coil electronic component 1000 shown in the above-mentioned cross-sectional photograph.

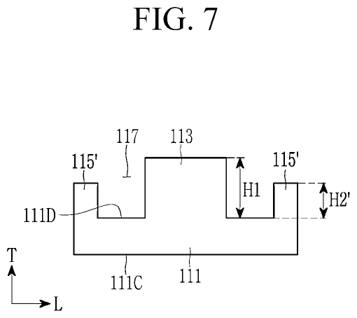

In some embodiments, as illustrated in FIG. 7, the protruding portion 113 and the support portion 115′ may have different heights. For example, a height H2′ of the support portion 115′ may be smaller than a height H1 of the protruding portion 113. However, because the support portion 115′ protrudes from a surface of the base portion 111, the height H2′ of the support portion 115′ is larger than 0.

The base portion 111 comprises part of the external appearance of the first magnetic body 110, and the protruding portion 113 and the support portion 115 are disposed on a surface of the base portion 111.

For example, the base portion 111 may include a front surface 111A and a rear surface 111B, which are opposite to each other in the width direction (W-axis direction), and a bottom surface 111C and an upper surface 111D that are opposite to each other in the thickness direction (T-axis direction). The bottom surface 111C of the base portion 111 may comprise the sixth surface S6 of the main body 100.

The protruding portion 113 is a portion protruding from the upper surface 111D of the base portion 111. For example, the protruding portion 113 may protrude from the center of the base portion 111 in the thickness direction (T-axis direction). The first coil 200 is wound around the protruding portion 113. The shape of the protruding portion 113 as viewed in the thickness direction (T-axis direction) is not particularly limited and may be a circular shape, an elliptical shape, a polygonal shape such as a triangular shape and a quadrangular shape, etc. The protruding portion 113 may have various publicly-known shapes that may be accommodated in a hollow space of the first coil 200. For example, in the cross-section taken in the length direction (L-axis direction) and the width direction (W-axis direction), the shape of the protruding portion may be the same as the shape of a hollow space of the first coil.

The support portion 115 is a portion protruding from the upper surface 111D of the base portion 111. Because the support portion 115 protrudes from the edge of the base portion 111 in the thickness direction (T-axis direction), the support portion 115 is spaced apart from the protruding portion 113.

The support portion 115 may be plural.

The support portion 115 may include a first support portion 115A, a second support portion 115B, a third support portion 115C, and a fourth support portion 115D. The first support portion 115A and the second support portion 115B face each other in the length direction (L-axis direction), and the third support portion 115C and the fourth support portion 115D face each other in the width direction (W-axis direction).

The first to fourth support portions 115A, 115B, 115C, and 115D may not be connected to one another. That is, between each of the first to fourth support portions 115A, 115B, 115C, and 115D, there may exist first to fourth grooves 117A, 117B, 117C, and 117D, as described below. Through the first to fourth grooves 117A, 117B, 117C, and 117D, the lead-out portions 223, 225, 323, and 325 of the first and second coils 200 and 300 may be drawn out and connected to the external electrodes 500, 600, 700, and 800.

The concave portion 117 is a region between the protruding portion 113 and the support portion 115. The first coil 200 may be disposed in the concave portion 117 and wound around the protruding portion 113. That is, by disposing the protruding portion 113 to penetrate the hollow space of the first coil 200, the first coil 200 may be accommodated within the concave portion 117 of the first magnetic body 110. The concave portion 117 may be sized to sufficiently accommodate the first coil 200. However, the concave portion 117 may subsequently contract as the protruding portion 113 and the support portion 115 of the first magnetic body 110 expand transversely under pressure during a process of pressing the second magnetic body 120 and the third magnetic body 130 onto the first magnetic body 110. The first coil 200 may come into close contact with the protruding portion 113 and the support portion 115 as the concave portion 117 contracts. Meanwhile, in this process, the third magnetic body 130 may extend under pressure between the first coil 200 and the protruding portion 113 and may extend between the first coil 200 and the support portion 115. That is, a portion of the third magnetic body 130 may exist between the first coil 200 and the protruding portion 113, and a portion of the third magnetic body 130 may exist between the first coil 200 and the support portion 115. In other words, the third magnetic body 130 may be at least partially in contact with the first coil 200, the protruding portion 113, and the support portion 115.

On the other hand, in case that the support portion 115 is not disposed in the first magnetic body 110 and only the protruding portion 113 is disposed, that is, in case that the cross-section of the first magnetic body 110 taken in the length direction (L-axis direction) and the thickness direction (T-axis direction) is in the shape of the letter T, in the process of pressing the second magnetic body 120 and the third magnetic body 130 onto the first magnetic body 110, the region around the protruding portion 113 of the first magnetic body 110 is filled with the second magnetic body 120 and the third magnetic body 130. However, since the support portion 115 is not disposed in the first magnetic body 110, the second magnetic body 120 and the third magnetic body 130 may flow (or penetrate) into the region around the protruding portion 113 without being subjected to opposing pressure (or resistive force) from the support portion 115, causing the second coil 300 to move with the movement of the second magnetic body 120 and the third magnetic body 130, resulting in a misalignment of the second coil 300.

In contrast, according to the present embodiment, since the first magnetic body 110 is in the shape of the letter E which includes the protruding portion 113 as well as the support portion 115, the second magnetic body 120 and the third magnetic body 130 may flow (penetrate) into the concave portion 117 of the first magnetic body 110 under opposing pressure (or resistive force) from the support portion 115, so that the movement of the second coil 300 is relatively limited, thereby reducing misalignment.

The base portion 111 may have the first to fourth grooves 117A, 117B, 117C, and 117D.

The first groove 117A and the second groove 117B may be disposed at two opposite sides in the length direction (L-axis direction) across the front surface 111A and the bottom surface 111C of the base portion 111, respectively. The first groove 117A and the second groove 117B do not extend to the rear surface 111B of the base portion 111. The first groove 117A and the second groove 117B may guide the first and second lead-out portions 223 and 225 of the first coil 200. For example, the first lead-out portion 223 may extend along the first groove 117A and be connected to the first external electrode 500, and the second lead-out portion 225 may extend along the second groove 117B and be connected to the second external electrode 600. However, the present embodiment is not limited thereto. The first and second lead-out portions may extend in various directions.

The first groove 117A and the second groove 117B may respectively have depths and widths that may accommodate the first lead-out portion 223 and the second lead-out portion 225. For example, the depth of each of the first and second grooves 117A and 117B may be the same as or smaller than the thickness of each of the first and second lead-out portions 223 and 225. The width of each of the first and second grooves 117A and 117B may be the same as or larger than the width of each of the first and second lead-out portions 223 and 225.

The third groove 117C and the fourth groove 117D may be disposed at two opposite sides in the length direction (L-axis direction) across the rear surface 111B and the bottom surface 111C of the base portion 111, respectively. The third groove 117C and the fourth groove 117D do not extend to the front surface 111A of the base portion 111. The third groove 117C and the fourth groove 117D may guide the first and second lead-out portions 323 and 325 of the second coil 300. For example, the first lead-out portion 323 may extend along the third groove 117C and be connected to the third external electrode 700, and the second lead-out portion 325 may extend along the fourth groove 117D and be connected to the fourth external electrode 800. However, the present embodiment is not limited thereto. The first and second lead-out portions may extend in various directions.

The third groove 117C and the fourth groove 117D may respectively have depths and widths that may accommodate the first lead-out portion 323 and the second lead-out portion 325. For example, the depth of each of the third and fourth grooves 117C and 117D may be the same as or smaller than the thickness of each of the first and second lead-out portions 323 and 325, and the width of each of the third and fourth grooves 117C and 117D may be the same as or larger than the width of each of the first and second lead-out portions 323 and 325.

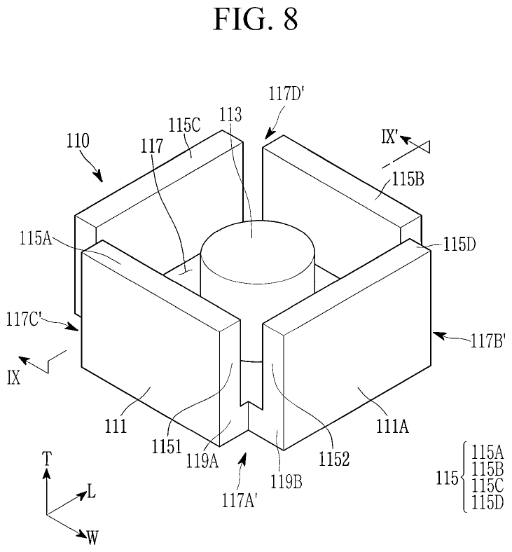

As another example, with reference to FIG. 8, the first groove 117A′ may have a shape in which a portion of the front surface 111A of the base portion 111 is recessed toward the rear surface 111B. In this case, a side surface 1151 of the first support portion 115A may comprise the same surface as an exposed surface 119A of the base portion 111, and a side surface 1152 of the fourth support portion 115D may comprise the same surface as an exposed surface 119B of the base portion 111. The second groove 117B′, the third groove 117C′, and the fourth groove 117D′ may also have the same shape as the first groove 117A′.

However, the base may not necessarily have a groove, and may not have a groove depending on how the base portion is formed or how the lead-out portion is arranged.

The second magnetic body 120 includes a second core 123. The second core 123 may be a region in which the hollow space of the second coil 300 is at least partially filled with the second magnetic body 120.

The second magnetic body 120 surrounds at least a portion of the second coil 300 and comprises a portion of the external appearance of the main body 100. That is, the second magnetic body 120 may comprise a portion of the first surface S1, a portion of the second surface S2, a portion of the third surface S3, a portion of the fourth surface S4, and the fifth surface S5 of the main body 100.

The method of forming the second magnetic body 120 is not particularly limited. For example, the second magnetic body 120 may be formed by placing a sheet of magnetic material on an upper portion of the second coil 300 and compressing and curing the sheet.

As described above, the second core 123 may be a portion formed by filling the hollow space of the second coil 300 during the process of forming the second magnetic body 120 by pressing the sheet of magnetic material onto the second coil 300. On the other hand, since the first magnetic body 110 has an integral structure, the protruding portion 113 of the first magnetic body 110 protrudes from the base portion 111 and penetrates the hollow space of the first coil 200.

The third magnetic body 130 is disposed between the first magnetic body 110 and the second magnetic body 120. For example, the third magnetic body 130 may be in contact with the first magnetic body 110 and the second magnetic body 120, respectively.

The third magnetic body 130 may include a first surface 131 and a second surface 133 that are opposed in the thickness direction (T-axis direction). The first surface 131 of the third magnetic body 130 may be in contact with the protruding portion 113 and the support portion 115 of the first magnetic body 110. In addition, the first surface 131 of the third magnetic body 130 may be in contact with a portion of the first coil 200, for example, the first coil surface 201. That is, the third magnetic body 130 may be in contact with the first coil 200, the protruding portion 113 and the support portion 115 of the first magnetic body 110.

Additionally, the third magnetic body 130 may be in contact with a portion of the second magnetic body 120 and a portion of the second coil 300. That is, the second surface 133 of the third magnetic body 130 may be in contact with a surface of the second magnetic body 120 opposite to the first magnetic body 110, and the second surface 133 of the third magnetic body 130 may be in contact with the second coil surface 302 of the second coil 300.

The third magnetic body 130 may have a rectangular shape when viewed in the thickness direction (T-axis direction). However, the present embodiment is not limited thereto. For example, the third magnetic body 130 may have a shape similar to the wound portion 210 of the first coil 200 or the wound portion 310 of the first coil 200.

The third magnetic body 130 may extend to the edge of the first magnetic body 110. That is, an outer surface of the third magnetic body 130 and an outer surface of the first magnetic body 110 may comprise an outer surface (e.g., the first surface S1 or the second surface S2) of the main body 100.

Meanwhile, the third magnetic body 130 may not extend to the edge of the first magnetic body 110. In this case, the third magnetic body 130 does not comprise the outer surface of the main body 100. In other words, the edge of the third magnetic body 130 is in contact with the first magnetic body 110.

The third magnetic body 130 may include magnetic materials to affect the magnetic coupling properties of the first coil 200 and the second coil 300. The third magnetic body 130 may include magnetic particles, and insulating materials may be interposed between the magnetic particles.

The magnetic permeability of the third magnetic body 130 may be smaller than the magnetic permeability of the first magnetic body 110 and smaller than the magnetic permeability of the second magnetic body 120. In this case, the third magnetic body 130 may be made of a material different from the materials of the first and second magnetic bodies 110 and 120. The composition of the material of the magnetic body may be inferred from a scanning electron microscope (SEM) photograph of the coil electronic component. Further, the magnetic permeability of the first magnetic body 110, the magnetic permeability of the second magnetic body 120, and the magnetic permeability of the third magnetic body 130 may be appropriately set to regulate the coupling coefficients (coefficients of coupling, k) of the first coil 200 and the second coil 300.

For example, as a method of adjusting the magnetic permeability of the first magnetic body 110 (or the second magnetic body 120) and the third magnetic body 130, a volume fraction of the first magnetic particles included in the first magnetic body 110 (or the second magnetic body 120) and a volume fraction of the second magnetic particles included in the third magnetic body 130 may be made different. In this case, the volume fraction of the magnetic particles means a ratio of a volume of the first magnetic particles to a volume of the first magnetic body 110 (or the second magnetic body 120) or a ratio of a volume of the second magnetic particles to a volume of the third magnetic body 130. To adjust the relative magnetic permeability of the first magnetic body 110 (or the second magnetic body 120) and the third magnetic body 130 by volume fraction of the first and second magnetic particles, the first and second magnetic particles may be made of the same material, for example, a metal alloy of the same composition. Meanwhile, as a method of adjusting the magnetic permeability of the first magnetic body 110 (or the second magnetic body 120) and the third magnetic body 130, an area fraction of the first magnetic particles included in the first magnetic body 110 (or the second magnetic body 120) and an area fraction of the second magnetic particles included in the third magnetic body 130 may be made different, when confirmed in cross-sectional area. In this case, the area fraction of the magnetic particles means a ratio of a cross-sectional area of the first magnetic particles to a cross-sectional area of the first magnetic body 110 (or the second magnetic body 120) or a ratio of a cross-sectional area of the second magnetic particles to a cross-sectional area of the third magnetic body 130.

A case where the magnetic permeability of the third magnetic body 130 is smaller than the magnetic permeability of the first magnetic body 110 (or the second magnetic body 120) may be a case where the volume fraction of the second magnetic particles included in the third magnetic body 130 is smaller than the volume fraction of the first magnetic particles included in the first magnetic body 110 (or the second magnetic body 120). If the magnetic permeability of the third magnetic body 130 is smaller than the magnetic permeability of the first magnetic body 110 (or the second magnetic body 120), the coupling coefficient of the first coil 200 and the second coil 300 may increase relatively. In this case, a relative increase in the coupling coefficient means that the coupling coefficient is larger compared to the case where the magnetic permeability of the third magnetic body 130 is the same as the magnetic permeability of the first magnetic body 110 (or the second magnetic body 120). In case that the magnetic permeability of the third magnetic body 130 is relatively small, the amount of magnetic flux flowing in the third magnetic body 130 is relatively small, and the mutual inductance due to the magnetic flux shared by the first coil 200 and the second coil 300 increases. In this case, the magnetic flux flowing in the third magnetic body 130 may be understood as flowing through the third magnetic body 130 in the length direction (L-axis direction), as illustrated in FIG. 4.

As a result, the mutual inductance of the first coil 200 and the second coil 300 becomes larger, and the leakage inductance that is created only in the first coil 200 or the second coil 300 becomes smaller, so the coupling coefficient of the first coil 200 and the second coil 300 becomes larger.

The first external electrode 500 and the second external electrode 600 are disposed outside the main body 100 and electrically connected to the first coil 200.

The first external electrode 500 is disposed on the sixth surface S6 of the main body 100, and the first lead-out portion 223 of the first coil 200 is exposed from the sixth surface S6 of the main body 100 and connected to the first external electrode 500.

The second external electrode 600 is disposed on the sixth surface S6 of the main body 100, and the second lead-out portion 225 of the first coil 200 is exposed from the sixth surface S6 of the main body 100 and connected to the second external electrode 600.

The first external electrode 500 and the second external electrode 600 may each be made of a conductive material such as copper (Cu), aluminum (Al), silver (Ag), tin (Sn), gold (Au), nickel (Ni), lead (Pb), chromium (Cr), titanium (Ti), or an alloy thereof. However, the present embodiment is not limited thereto.

The first external electrode 500 and the second external electrode 600 may each include a plurality of metal layers formed by plating a conductive metal.

With reference to the left circle in FIG. 1, the first external electrode 500 may include a first metal layer 501, a second metal layer 502, and a third metal layer 503.

The first metal layer 501 may be a plating layer in contact with the first lead-out portion 223 of the first coil 200 and the outer surface of the main body 100 and include copper (Cu). The second metal layer 502 may be a plating layer that covers the first metal layer 501 and include nickel (Ni). The third metal layer 503 may be a plating layer that covers the second metal layer 502 and include tin (Sn). However, the present embodiment is not limited to the three-layer structure, and a two-layer structure with only one plating layer added onto the first metal layer 501 is also possible.

With reference to the right circle in FIG. 1, the second external electrode 600 may include a first metal layer 601, a second metal layer 602, and a third metal layer 603.

The first metal layer 601 may be a plating layer in contact with the second lead-out portion 225 of the first coil 200 and the outer surface of the main body 100 and include copper (Cu). The second metal layer 602 may be a plating layer that covers the first metal layer 601 and include nickel (Ni). The third metal layer 603 may be a plating layer that covers the second metal layer 602 and include tin (Sn). However, the present embodiment is not limited to the three-layer structure, and a two-layer structure with only one plating layer added onto the first metal layer 601 is also possible.

As described above, the first and second external electrodes 500 and 600 may each include nickel (Ni), copper (Cu), palladium (Pd), gold (Au), or an alloy thereof and include a plurality of plating layers. For example, the first and second external electrodes 500 and 600 may each be made of a combination of nickel (Ni) layer, copper (Cu) layer, nickel/copper (Ni/Cu) layer, palladium/nickel (Pd/Ni) layer, palladium/nickel/copper (Pd/Ni/Cu) layer, and copper/nickel/copper (Cu/Ni/Cu) layer.

In some embodiments, an outermost layer may comprise tin (Sn). Because the tin plating layer has a relatively low melting point, it is possible to improve ease of substrate mounting the first and second external electrodes 500 and 600.

In general, a tin plating layer may be connected to an electrode pad on a substrate through solder containing tin (Sn)-copper (Cu)-silver (Ag) alloy paste. That is, the tin plating layer may melt and bond to the solder during a heat treatment (reflow) process.

As another example, the first and second external electrodes 500 and 600 may each include a plurality of electrode layers. For example, the first and second external electrodes 500 and 600 may each include a first electrode layer, a second electrode layer that covers the first electrode layer, and a third electrode layer that covers the second electrode layer. The first electrode layer may include copper (Cu) and be a conductive resin layer. The conductive resin layer may include conductive metal for ensuring electrical conductivity, and resin for absorbing impact. The resin is not particularly limited as long as it has bonding and impact absorbing properties and may be mixed with conductive metal powder to form a paste, and may include, for example, phenolic resin, acrylic resin, silicone resin, epoxy resin, or polyimide resin. For example, the conductive metal may include copper (Cu), tin (Sn), nickel (Ni), silver (Ag), palladium (Pd), gold (Au), platinum (Pt), tungsten (W), titanium (Ti), alloys thereof, or combinations thereof.

The third external electrode 700 and the fourth external electrode 800 are disposed outside the main body 100 and electrically connected to the second coil 300.

The third external electrode 700 is disposed on the sixth surface S6 of the main body 100, and the first lead-out portion 323 of the second coil 300 is exposed from the sixth surface S6 of the main body 100 and connected to the third external electrode 700.

The fourth external electrode 800 is disposed on the sixth surface S6 of the main body 100, and the second lead-out portion 325 of the second coil 300 is exposed from the sixth surface S6 of the main body 100 and connected to the fourth external electrode 800.

Because the structures and components of the third and fourth external electrodes 700 and 800 are the same as the first and second external electrodes 500 and 600, a repeated description thereof will be omitted.

Meanwhile, an insulation layer 900 may be disposed on the main body 100 of the coil electronic component 1000 according to the present embodiment, except for a region where the first external electrode 500, the second external electrode 600, the third external electrode 700, and the fourth external electrode 800 are disposed. Alternatively, an insulation layer may be present between the portion where the first lead-out portion 223 of the first coil 200 is exposed, the portion where the second lead-out portion 225 of the first coil 200 is exposed, the portion where the first lead-out portion 323 of the second coil 300 is exposed, and the portion where the second lead-out portion 325 of the second coil 300 is exposed on the sixth surface S6 of the main body 100. In this case the first external electrode 500, the second external electrode 600, the third external electrode 700, and the fourth external electrode 800 may cover a portion of the insulation layer.

As described above, the insulation layer 900 may be disposed on at least portions of the first surface S1, the second surface S2, the third surface S3, the fourth surface S4, the fifth surface S5, and the sixth surface S6 of the main body 100 and prevent an electrical short circuit between other electronic component(s) and the external electrodes 500, 600, 700, and 800.

The insulation layer 900 may serve as a resist when forming the external electrodes 500, 600, 700, and 800 by electroplating. However, the present embodiment is not limited thereto.

Meanwhile, the shapes of the external electrodes 500, 600, 700, and 800 according to the present embodiment are not limited to the above-mentioned shapes but may be of various shapes.

For example, the first external electrode 500 may be connected to the first lead-out portion 223 of the first coil 200 on the sixth surface S6 of the main body 100 and extend to the second surface S2 of the main body 100. In addition, the second external electrode 600 may be connected to the second lead-out portion 225 of the first coil 200 on the sixth surface S6 of the main body 100 and extend to the first surface S1 of the main body 100. The third external electrode 700 may be connected to the first lead-out portion 323 of the second coil 300 on the sixth surface S6 of the main body 100 and extend to the first surface S1 of the main body 100. In addition, the fourth external electrode 800 may be connected to the second lead-out portion 325 of the second coil 300 on the sixth surface S6 of the main body 100 and extend to the second surface S2 of the main body 100.

As still another example, the first external electrode 500 may be connected to the first lead-out portion 223 of the first coil 200 on the sixth surface S6 of the main body 100 and extend to the second surface S2 and the fifth surface S5 of the main body 100. In addition, the second external electrode 600 may be connected to the second lead-out portion 225 of the first coil 200 on the sixth surface S6 of the main body 100 and extend to the first surface S1 and the fifth surface S5 of the main body 100. The third external electrode 700 may be connected to the first lead-out portion 323 of the second coil 300 on the sixth surface S6 of the main body 100 and extend to the first surface S1 and the fifth surface S5 of the main body 100. In addition, the fourth external electrode 800 may be connected to the second lead-out portion 325 of the second coil 300 on the sixth surface S6 of the main body 100 and extend to the second surface S2 and the fifth surface S5 of the main body 100.

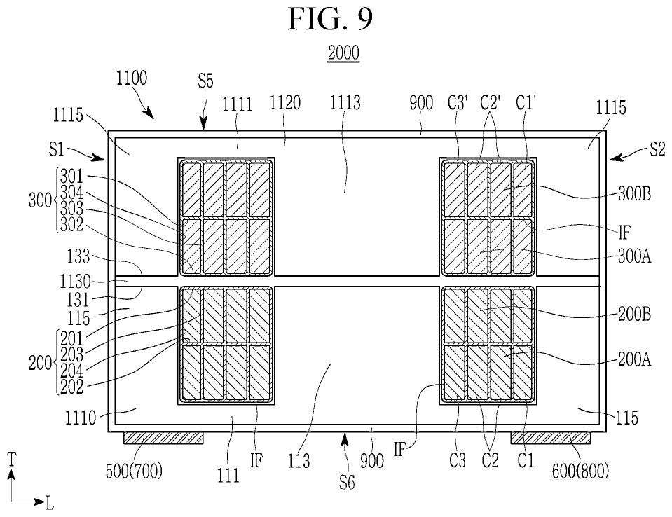

FIG. 9 is a cross-sectional view schematically illustrating a coil electronic component according to another embodiment.

With reference to FIG. 9, a coil electronic component 2000 may include a main body 1100, a first coil 200, a second coil 300, a first external electrode 500, a second external electrode 600, a third external electrode 700, and a fourth external electrode 800.

The main body 1100 may include a first magnetic body 1110, a second magnetic body 1120, and a third magnetic body 1130.

The first magnetic body 1110 surrounds and encapsulates the first coil 200 and includes magnetic materials. The first magnetic body 1110 may include a base portion 111, a protruding portion 113, and a support portion 115, and the cross-section taken in the length direction (L-axis direction) and the thickness direction (T-axis direction) may have a letter E shape.

The second magnetic body 1120 surrounds and encapsulates the second coil 300 and includes magnetic materials. The second magnetic body 1120 may include a base portion 1111, a protruding portion 1113, and a support portion 1115, and the cross-section taken in the length direction (L-axis direction) and the thickness direction (T-axis direction) may have a letter E shape. That is, the protruding portion 1113 is disposed at a center of the base portion 1111, and the support portions 1115 are respectively disposed at two opposite edges of the base portion 1111 and spaced apart from the protruding portion 1113. The second magnetic body 1120 has the same or corresponding shape as the first magnetic body 1110, and therefore redundant description thereof will be omitted.

The third magnetic body 1130 is disposed between the first magnetic body 1110 and the second magnetic body 1120.

The third magnetic body 1130 may be in contact with the first coil 200 and the protruding portion 113 and the support portion 115 of the first magnetic body 1110. A portion of the third magnetic body 1130 may exist between the first coil 200 and the protruding portion 113, and a portion of the third magnetic body 1130 may exist between the first coil 200 and the support portion 115.

In addition, the third magnetic body 1130 may be in contact with the second coil 300 and the protruding portion 1113 and the support portion 1115 of the second magnetic body 1120. A portion of the third magnetic body 1130 may exist between the second coil 300 and the protruding portion 1113, and a portion of the third magnetic body 1130 may exist between the second coil 300 and the support portion 1115.

With the exception of the above, the remaining components are identical to those of the coil electronic component illustrated in FIG. 1, and thus redundant description thereof will be omitted.

Hereinafter, specific examples of the present disclosure will be described. However, the examples described below are intended only to specifically illustrate and explain the present disclosure, and the scope of the present disclosure should not be limited thereto.

### Preparation Examples: Manufacture of Coil Electronic Component

### Example 1

A coil electronic component in which the thickness of each of the first and second coils of the coil electronic component is 200 um, the width of each of the first and second coils is 40 um, and the aspect ratio is 5:1 is manufactured.

### Example 2

Example 2 is identical to Example 1 except that the thickness of each of the first and second coils of the coil electronic component is 198 um, the width of each of the first and second coils is 41 um, and the aspect ratio is about 4.83:1.

### Example 3

Example 3 is identical to Example 1 except that the thickness of each of the first and second coils of the coil electronic component is 195 um, the width of each of the first and second coils is 41 um, and the aspect ratio is about 4.76:1.

### Example 4

Example 4 is identical to Example 1 except that the thickness of each of the first and second coils of the coil electronic component is 193 um, the width of each of the first and second coils is 42 um, and the aspect ratio is about 4.59:1.

### Example 5

Example 5 is identical to Example 1 except that the thickness of each of the first and second coils of the coil electronic component is 190 um, the width of each of the first and second coils is 42 um, and the aspect ratio is about 4.52:1.

### Example 6

Example 6 is identical to Example 1 except that the thickness of each of the first and second coils of the coil electronic component is 188 um, the width of each of the first and second coils is 43 um, and the aspect ratio is about 4.37:1.

### Example 7

Example 7 is identical to Example 1 except that the thickness of each of the first and second coils of the coil electronic component is 185 um, the width of each of the first and second coils is 43 um, and the aspect ratio is about 4.3:1.

### Example 8

Example 8 is identical to Example 1 except that the thickness of each of the first and second coils of the coil electronic component is 183 um, the width of each of the first and second coils is 44 um, and the aspect ratio is about 4.16:1.

### Example 9

Example 9 is identical to Example 1 except that the thickness of each of the first and second coils of the coil electronic component is 180 um, the width of each of the first and second coils is 44 um, and the aspect ratio is about 4.09:1.

### Example 10

Example 10 is identical to Example 1 except that the thickness of each of the first and second coils of the coil electronic component is 178 um, the width of each of the first and second coils is 45 um, and the aspect ratio is about 3.96:1.

### Example 11

Example 11 is identical to Example 1 except that the thickness of each of the first and second coils of the coil electronic component is 175 um, the width of each of the first and second coils is 46 um, and the aspect ratio is about 3.8:1.

### Example 12

Example 12 is identical to Example 1 except that the thickness of each of the first and second coils of the coil electronic component is 150 um, the width of each of the first and second coils is 53 um, and the aspect ratio is about 2.83:1.

### Example 13

Example 13 is identical to Example 1 except that the thickness of each of the first and second coils of the coil electronic component is 125 um, the width of each of the first and second coils is 64 um, and the aspect ratio is about 1.95:1.

### Example 14

Example 14 is identical to Example 1 except that the thickness of each of the first and second coils of the coil electronic component is 123 um, the width of each of the first and second coils is 65 um, and the aspect ratio is about 1.89:1.

### Example 15

Example 15 is identical to Example 1 except that the thickness of each of the first and second coils of the coil electronic component is 120 um, the width of each of the first and second coils is 67 um, and the aspect ratio is about 1.79:1.

### Example 16

Example 16 is identical to Example 1 except that the thickness of each of the first and second coils of the coil electronic component is 118 um, the width of each of the first and second coils is 68 um, and the aspect ratio is about 1.74:1.

### Example 17

Example 17 is identical to Example 1 except that the thickness of each of the first and second coils of the coil electronic component is 115 um, the width of each of the first and second coils is 70 um, and the aspect ratio is about 1.64:1.

### Example 18

Example 18 is identical to Example 1 except that the thickness of each of the first and second coils of the coil electronic component is 113 um, the width of each of the first and second coils is 71 um, and the aspect ratio is about 1.59:1.

### Example 19

Example 19 is identical to Example 1 except that the thickness of each of the first and second coils of the coil electronic component is 110 um, the width of each of the first and second coils is 73 um, and the aspect ratio is about 1.5:1.

### Example 20

Example 20 is identical to Example 1 except that the thickness of each of the first and second coils of the coil electronic component is 108 um, the width of each of the first and second coils is 74 um, and the aspect ratio is about 1.46:1.

### Example 21

Example 21 is identical to Example 1 except that the thickness of each of the first and second coils of the coil electronic component is 105 um, the width of each of the first and second coils is 76 um, and the aspect ratio is about 1.38:1.

### Example 22

Example 22 is identical to Example 1 except that the thickness of each of the first and second coils of the coil electronic component is 103 um, the width of each of the first and second coils is 78 um, and the aspect ratio is about 1.32:1.

### Example 23

Example 23 is identical to Example 1 except that the thickness of each of the first and second coils of the coil electronic component is 100 um, the width of each of the first and second coils is 80 um, and the aspect ratio is 1.25:1.

### Comparative Example 1

Comparative Example 1 is identical to Example 1 except that the thickness of each of the first and second coils of the coil electronic component is 300 um, the width of each of the first and second coils is 27 um, and the aspect ratio is about 11.1:1.

### Comparative Example 2

Comparative Example 2 is identical to Comparative Example 1 except that the thickness of each of the first and second coils of the coil electronic component is 275 um, the width of each of the first and second coils is 29 um, and the aspect ratio is about 9.48:1.

### Comparative Example 3

Comparative Example 3 is identical to Comparative Example 1 except that the thickness of each of the first and second coils of the coil electronic component is 250 um, the width of each of the first and second coils is 32 um, and the aspect ratio is about 7.81:1.

### Comparative Example 4

Comparative Example 4 is identical to Comparative Example 1 except that the thickness of each of the first and second coils of the coil electronic component is 225 um, the width of each of the first and second coils is 36 um, and the aspect ratio is 6.25:1.

### Comparative Example 5

Comparative Example 5 is identical to Comparative Example 1 except that the thickness of each of the first and second coils of the coil electronic component is 75 um, the width of each of the first and second coils is 107 um, and the aspect ratio is about 0.7:1.

### Comparative Example 6

Comparative Example 6 is identical to Comparative Example 1 except that the thickness of each of the first and second coils of the coil electronic component is 50 um, the width of each of the first and second coils is 160 um, and the aspect ratio is about 0.31:1.

### Experimental Examples: Whether Inductance of Coil Electronic Component is Poor

After manufacturing 30 pieces of coil electronic components of Examples 1 to 23 and Comparative Examples 1 to 6, by grinding a surface in the length direction (L-axis direction) and the thickness direction (T-axis direction) to a depth of about ½ in the width direction (W-axis direction) to prepare cross-sectional samples.

For the prepared cross-section samples, the aspect ratio (w:t) is calculated by measuring the width (w) and thickness (t) of the coil, the diameter (d) of the core is measured, whether the coupling coefficient (k) of the coil electronic component is within the allowable range (greater than 0.1 and less than 0.9) is checked, and the results are summarized in Table 1.

TABLE 1

| | w (um) | t (um) | w:t | d (mm) | k | Result |
|---|---|---|---|---|---|---|
| Comparative | 300 | 27 | 11.1:1 | 0 | −1.14 | Poor |
| Example 1 | | | | | | |
| Comparative | 275 | 29 | 9.48:1 | 0.1 | −0.69 | Poor |
| Example 2 | | | | | | |
| Comparative | 250 | 32 | 7.81:1 | 0.2 | −0.33 | Poor |
| Example 3 | | | | | | |
| Comparative | 225 | 36 | 6.25:1 | 0.3 | −0.04 | Poor |
| Example 4 | | | | | | |
| Example 1 | 200 | 40 | 5:1 | 0.4 | 0.17 | Good |
| Example 2 | 198 | 41 | 4.83:1 | 0.41 | 0.18 | Good |
| Example 3 | 195 | 41 | 4.76:1 | 0.42 | 0.20 | Good |
| Example 4 | 193 | 42 | 4.59:1 | 0.43 | 0.21 | Good |
| Example 5 | 190 | 42 | 4.52:1 | 0.44 | 0.23 | Good |
| Example 6 | 188 | 43 | 4.37:1 | 0.45 | 0.24 | Good |
| Example 7 | 185 | 43 | 4.3:1 | 0.46 | 0.25 | Good |
| Example 8 | 183 | 44 | 4.16:1 | 0.47 | 0.26 | Good |
| Example 9 | 180 | 44 | 4.09:1 | 0.48 | 0.27 | Good |
| Example 10 | 178 | 45 | 3.96:1 | 0.49 | 0.28 | Good |
| Example 11 | 175 | 46 | 3.8:1 | 0.5 | 0.29 | Good |
| Example 12 | 150 | 53 | 2.83:1 | 0.6 | 0.33 | Good |
| Example 13 | 125 | 64 | 1.95:1 | 0.7 | 0.29 | Good |
| Example 14 | 123 | 65 | 1.89:1 | 0.71 | 0.29 | Good |
| Example 15 | 120 | 67 | 1.79:1 | 0.72 | 0.28 | Good |
| Example 16 | 118 | 68 | 1.74:1 | 0.73 | 0.27 | Good |
| Example 17 | 115 | 70 | 1.64:1 | 0.74 | 0.26 | Good |
| Example 18 | 113 | 71 | 1.59:1 | 0.75 | 0.24 | Good |
| Example 19 | 110 | 73 | 1.5:1 | 0.76 | 0.23 | Good |
| Example 20 | 108 | 74 | 1.46:1 | 0.77 | 0.22 | Good |
| Example 21 | 105 | 76 | 1.38:1 | 0.78 | 0.20 | Good |
| Example 22 | 103 | 78 | 1.32:1 | 0.79 | 0.19 | Good |
| Example 23 | 100 | 80 | 1.25:1 | 0.8 | 0.17 | Good |
| Comparative | 75 | 107 | 0.7:1 | 0.9 | −0.03 | Poor |
| Example 5 | | | | | | |
| Comparative | 50 | 160 | 0.31:1 | 1 | −0.31 | Poor |
| Example 6 | | | | | | |

With reference to Table 1, it can be confirmed that the coupling coefficient of the coil electronic component manufactured according to Comparative Examples 1 to 6 is negative and therefore outside the allowable range (greater than 0.1 and less than 0.9). In Comparative Examples 1 to 4, the diameter of the core is relatively small, so the magnetic path area is also small, and as a result, the coupling coefficient is negative. In Comparative Examples 5 to 6, the diameter of the core is relatively very large, but the aspect ratios of the coils are very small, 0.7:1 and 0.31:1, respectively, which led to a problem with coupling coefficient characteristics.

Meanwhile, it can be confirmed that the coupling coefficient of the coil electronic component manufactured according to Examples 1 to 23 is within the allowable range (greater than 0.1 and less than 0.9).

While the embodiments of the present disclosure have been described above, the present disclosure is not limited thereto, and various modifications can be made and carried out within the scope of the claims, the detailed description of the present disclosure, and the accompanying drawings, and also fall within the scope of the present disclosure.

### DESCRIPTION OF SYMBOLS

1000: Coil electronic component
100: Main body
110: First magnetic body
111: Base portion
113: Protruding portion
115: Support portion
117: Concave portion
120: Second magnetic body
123: Second core
130: Third magnetic body
200: First coil
210: Wound portion
220: Lead-out portion
223: First lead-out portion
225: Second lead-out portion
300: Second coil
310: Wound portion
320: Lead-out portion
323: First lead-out portion
325: Second lead-out portion
500: First external electrode
600: Second external electrode
700: Third external electrode
800: Fourth external electrode
900: Insulation layer
IF: Insulation film

What is claimed is:

1. A coil electronic component comprising:
a main body including a first magnetic body, and a second magnetic body facing the first magnetic body;
a first coil, at least a portion of which is embedded in the first magnetic body; and
a second coil, at least a portion of which is embedded in the second magnetic body,
wherein the first magnetic body is an integral structure having a recess, and
wherein the first coil is disposed in the recess.

2. The coil electronic component of claim 1, wherein:
the first magnetic body includes a base portion, a protruding portion protruding from the base portion, and a support portion spaced apart from the protruding portion and protruding from the base portion
the recess is defined by the base portion, the protruding portion and the support portion, and
the first coil is wound around the protruding portion.

3. The coil electronic component of claim 2, wherein:
the main body further includes a third magnetic body between the first magnetic body and the second magnetic body.

4. The coil electronic component of claim 3, wherein:
an outer surface of the third magnetic body and an outer surface of the first magnetic body comprise an outer surface of the main body.

5. The coil electronic component of claim 4, wherein:
the third magnetic body is at least partially in contact with the second coil and the second magnetic body.

6. The coil electronic component of claim 5, wherein:
a height of the protruding portion and a height of the support portion are different.

7. The coil electronic component of claim 3, wherein:
the third magnetic body is at least partially in contact with the first coil, the protruding portion, and the support portion.

8. The coil electronic component of claim 7, wherein:
the first coil is surrounded by the base portion, the protruding portion, the support portion, and the third magnetic body.

9. The coil electronic component of claim 7, wherein:
the third magnetic body includes a portion between the first coil and the protruding portion.

10. The coil electronic component of claim 7, wherein:
the third magnetic body includes a portion between the first coil and the support portion.

11. The coil electronic component of claim 1, wherein:
an aspect ratio of the first coil is 1.25:1 or more and 5:1 or less, and
an aspect ratio of the second coil is 1.25:1 or more and 5:1 or less.

12. The coil electronic component of claim 1, wherein:
a coupling coefficient of the first coil and the second coil is 0.17 or more and 0.33 or less.

13. The coil electronic component of claim 1, further comprising:
a first external electrode disposed outside the main body and connected to a first lead-out portion of the first coil;
a second external electrode disposed outside the main body and connected to a second lead-out portion of the first coil;
a third external electrode disposed outside the main body and connected to a first lead-out portion of the second coil; and
a fourth external electrode disposed outside the main body and connected to a second lead-out portion of the second coil.

14. The coil electronic component of claim 1, further comprising:
an insulation film on a surface of the first coil and a surface of the second coil.

15. The coil electronic component of claim 3, wherein:
the third magnetic body has magnetic permeability different from magnetic permeability of the first magnetic body and the second magnetic body.

16. The coil electronic component of claim 15, wherein:
the third magnetic body includes a material different from materials of the first magnetic body and the second magnetic body.

17. The coil electronic component of claim 3, wherein:
the first magnetic body, the second magnetic body, and the third magnetic body each include metal magnetic particles made of a soft magnetic alloy.

18. The coil electronic component of claim 2, wherein the second magnetic body includes a second base portion, a second protruding portion and a second support portion spaced apart from the second protruding portion, and wherein the second coil is wound around the second protruding portion.

19. The coil electronic component of claim 18, further comprising a third magnetic body in contact with the first coil, the protruding portion, the support portion, the second coil, the second protruding portion and the second support portion.

20. The coil electronic component of claim 19, wherein a portion of the third magnetic body is disposed between the second coil and the second protruding portion.

21. The coil electronic component of claim 19, wherein a portion of the third magnetic body is disposed between the second coil and the second support portion.

22. A coil electronic component, comprising:
a first coil having first and second lead-out portions;
a second coil having third and fourth lead-out portions, the second coil being magnetically coupled to the first coil;
a first magnetic body comprising an integral structure including a base portion, a protruding portion protruding from a central region of an upper surface of the base portion and a support portion protruding from a peripheral region of the upper surface of the base portion and spaced apart from the protruding portion;
first, second, third and fourth external electrodes disposed on a bottom surface of the base portion,
wherein the first coil is wound around the protruding portion,
wherein the base portion comprises first and second grooves disposed at length-wise opposite sides across a front surface of the base portion, and third and fourth grooves disposed at length-wise opposite sides across a rear surface opposing the front surface of the base portion, and
wherein the first to fourth lead portions are respectively connected to the first to fourth external electrodes respectively via the first to fourth grooves.

23. The coil electronic component of claim 22, further comprising a second magnetic body, wherein at least a portion of the second coil is embedded in the second magnetic body, and wherein the first magnetic body and the second magnetic body form a main body of the coil electronic component.

24. The coil electronic component of claim 22, wherein the first coil has an aspect ratio in a range from 1.25:1 to 5:1, wherein aspect ratio is defined as a ratio of the thickness and the width of the cross-section of the first coil.

25. The coil electronic component of claim 23, further comprising a third magnetic body disposed between the first magnetic body and the second magnetic body, wherein the third magnetic body includes a different magnetic material than that of the first and second magnetic bodies.

26. The coil electronic component of claim 25, wherein the first coil is surrounded by the base portion, the protruding portion, the support portion, and the third magnetic body, and the third magnetic body at least partially contacts the second coil and the second magnetic body.
